(19) United States
(12) Patent Application Publication
(10) Pub. No.: US 2009/0000548 A1
(43) Pub. Date: Jan. 1, 2009

(54) SUBSTRATE HOLDER AND VACUUM FILM DEPOSITION APPARATUS

(76) Inventor: Hiroshi SOHDA, Kanagawa (JP)

Correspondence Address: BIRCH STEWART KOLASCH & BIRCH, PO BOX 747, FALLS CHURCH, VA, 22040-0747, US

(21) Appl. No.: 12/144,249

(22) Filed: Jun. 23, 2008

(30) Foreign Application Priority Data
Jun. 29, 2007 (JP) 2007-173268

(51) Int. Cl. B05C 11/00

(52) U.S. Cl. 118/712

(57) ABSTRACT

A substrate holder includes a holding unit which holds a substrate, a temperature measurement unit which is provided at a surface on a substrate side of the holding unit and is brought into contact with the substrate to measure a temperature of the substrate and a signal output unit which outputs temperature measurement signals from the temperature measurement unit. A vacuum film deposition apparatus has at least one vacuum film deposition unit including the substrate holder a vacuum chamber, a holder support portion provided within the vacuum chamber, connected to a connection portion of the substrate holder and supporting the substrate holder, a film deposition device forming a film by vacuum film deposition on the substrate held in the substrate holder and a signal receiving unit connected to the signal output unit and receiving the temperature measurement signals.

### BACKGROUND OF THE INVENTION

The present invention relates to a substrate holder for supporting a substrate on which a film is vapor-deposited and a vacuum film deposition apparatus in which the substrate holder is used.

A radiation image detector which records a radiation image by first allowing a radiation (e.g. X-rays, α-rays, β-rays, γ-rays, electron beams or uv rays) to pass through an object, then picking up the radiation as an electric signal has conventionally been used in such applications as medical diagnostic imaging and industrial nondestructive testing.

Examples of this radiation image detector include a solid-state radiation detector (so-called “flat panel detector” which is hereinafter abbreviated as “FPD”) that picks up the radiation as an electric image signal, and an X-ray image intensifier that picks up the radiation image as a visible image.

FPDs are operated by one of two methods, direct conversion method and indirect conversion method; in the direct conversion method which involves the use of a film of photoconductive material such as amorphous selenium and a thin film transistor (TFT), electron hole pairs (e-h pairs) emitted from the photoconductive film upon incidence of radiation are collected and the collected e-h pairs are read as an electric signal by the TFT, whereby the radiation is “directly” converted to the electric signal; in the indirect conversion method, a phosphor layer (scintillator layer) which is formed of a phosphor that emits light (fluorescence) upon incidence of radiation is provided such that it converts the radiation to visible light, which is read with a photoelectric transducer, whereby the radiation “as visible light” is converted to an electric signal.

An exemplary apparatus for forming a phosphor layer or a film of photoconductive material such as amorphous selenium on a substrate includes a vacuum evaporation apparatus that forms a vapor-deposited film on a substrate by evaporating an evaporable material in a vacuum chamber evacuated to a predetermined pressure.

An example of the vacuum evaporation apparatus includes an apparatus for forming a vapor-deposited film as the substrate temperature is measured with a temperature-measuring means.

JP 2004-179355 A describes a vacuum apparatus in which the temperature of a substrate is measured with a thermocouple for measuring the substrate temperature which is held in contact with the substrate within a vacuum chamber, the thermocouple being provided in a transport mechanism where the thermocouple contacts the substrate, and more specifically within a sensor chip at the tip of a support pin for vertically moving the substrate. JP 2004-179355 A also describes that the sensor chip is preferably made of the same material as the substrate.

Although not directed to a vacuum evaporation apparatus, JP 2005-241132 A describes a multi-chamber heat treatment apparatus having a temperature measuring means which comprises at least a heating chamber for heating an object and a cooling chamber for cooling the object heated in the heating chamber, and which further comprises a sensor portion fixed to a specified part of a tray for transporting the object, a measuring portion electrically connected to the sensor portion and disposed outside, a connecting wire connected to the sensor portion at its one end and to the measuring portion at the other end for electrically connecting the sensor portion and the measuring portion, and a reel portion disposed in the cooling chamber and capable of taking up the connecting wire.

### SUMMARY OF THE INVENTION

The apparatus described in JP 2004-179355 A has the temperature measuring means provided in the transport mechanism of the vacuum apparatus, and suffers from the problem that the detection value varies with the state of contact with the substrate and the amount of contact. In particular, the vacuum apparatus has large measurement variations depending on the state of contact, thus posing a problem.

The apparatus described in JP 2005-241132 A has the sensor portion provided in the tray for transporting an object to enable the object to be moved without changing the state of contact with the sensor portion, thus achieving measurement of the substrate temperature with the state of contact unchanged. However, this layout requires wiring in the vacuum chamber using the reel portion and in the case where a plurality of vacuum chambers are provided, long wiring is necessary. In addition, The tray wiring extends over the vacuum chambers to prevent separate processing in the respective vacuum chambers and hence continuous processing of the object.

It is also possible to measure the substrate temperature using a radiation thermometer instead of the sensor brought into contact with the substrate as described above, but in the case of vacuum evaporation apparatuses, it is difficult to measure the temperature of the substrate surface on which a film is vapor-deposited. It is also difficult to measure the surface on which a film is not vapor-deposited with a radiation thermometer, because this surface is provided with a member for adjusting the substrate temperature and a substrate holding member.

The present invention has been made to solve the aforementioned problems and it is an object of the present invention to provide a substrate holder capable of measuring the substrate temperature under fixed conditions even in the case where a plurality of films are formed on the substrate by vapor deposition as it is moved through a plurality of vacuum chambers.

Another object of the present invention is to provide a vacuum film deposition apparatus capable of measuring the substrate temperature under fixed conditions, thus forming a more uniform high-quality film on the substrate by vapor deposition.

In order to achieve the above objects, the present invention provides a substrate holder comprising:

a holding unit which holds a substrate;

a temperature measurement unit which is provided at a surface on a substrate side of the holding unit and is brought into contact with the substrate to measure a temperature of the substrate; and

a signal output unit which outputs temperature measurement signals from the temperature measurement unit.

It is preferred that the temperature measurement unit in the substrate holder have measurement terminals for measuring the temperature of the substrate and measure the temperature at a plurality of positions of the substrate.

The signal output unit preferably outputs by radio the temperature measurement signals.

It is preferred that the substrate holder further comprise a thermally conductive member which is provided on the surface on the substrate side of the holding unit and that the temperature measurement unit be in contact with the substrate via the thermally conductive member.

The present invention also provides a vacuum film deposition apparatus comprising at least one vacuum film deposition unit, the at least one vacuum film deposition unit comprising:

a substrate holder including:
a holding unit which holds a substrate;
a temperature measurement unit which is provided at a surface on a substrate side of the holding unit and is brought into contact with the substrate to measure a temperature of the substrate; and
a signal output unit which outputs temperature measurement signals from the temperature measurement unit;

a vacuum chamber within which the substrate holder is provided;

a holder support portion which is provided within the vacuum chamber, is connected to a connection portion of the substrate holder and supports the substrate holder;

a film deposition device which forms a film by vacuum film deposition on the substrate held in the substrate holder supported by the holder support portion; and

a signal receiving unit which is connected to the signal output unit and receives the temperature measurement signals.

It is preferred for the vacuum film deposition apparatus to further comprise a temperature adjusting mechanism which adjusts the temperature of the substrate based on the temperature measurement signals received by the signal receiving unit.

It is preferred that the at least one vacuum film deposition unit comprise a plurality of vacuum film deposition units and that the vacuum film deposition apparatus further comprise a transport mechanism which transports the substrate holder from one of the plurality of vacuum film deposition units to another.

It is preferred that the temperature measurement unit in the vacuum film deposition apparatus have measurement terminals for measuring the temperature of the substrate and measure the temperature at a plurality of positions of the substrate.

The signal output unit preferably outputs by radio the temperature measurement signals.

It is preferred that the substrate holder further comprise a thermally conductive member which is provided on the surface on the substrate side of the holding unit and that the temperature measurement unit be in contact with the substrate via the thermally conductive member.

The present invention is capable of measurement of the substrate temperature under fixed conditions and a simplified apparatus layout. Even in the case of forming a plurality of films on the substrate, the substrate temperature can be measured under fixed conditions, thus achieving formation of a uniform, high-quality thin film on the substrate by vapor deposition.

The substrate temperature can be measured under fixed conditions without moving the substrate through a plurality of vacuum chambers with wiring kept connected to the substrate holder, thus enabling a high-quality film to be formed on the substrate with a simple apparatus layout.

### BRIEF DESCRIPTION OF THE DRAWINGS

FIG. 1A is a front view schematically showing the structure of a vacuum evaporation apparatus according to an embodiment of a vacuum film deposition apparatus of the present invention in which a substrate holder of the present invention is used;

FIG. 1B is an enlarged front view showing in an enlarged scale the substrate holder and a holder mounting section of the vacuum evaporation apparatus shown in FIG. 1A;

FIGS. 2A to 2E each schematically show a measurement unit of the substrate holder in the vacuum evaporation apparatus shown in FIG. 1A;

FIG. 3 schematically shows the structure of a signal output unit and a signal receiving unit in the substrate holder of the present invention;

FIGS. 4A and 4B are partial cross-sectional views each schematically showing the structure of the junction between the signal output unit and the signal receiving unit shown in FIG. 3;

FIG. 5A is a front view schematically showing the structure of another embodiment of the substrate holder;

FIG. 5B is a front view schematically showing the structure of still another embodiment of the substrate holder;

FIG. 5C is a front view schematically showing the structure of yet another embodiment of the substrate holder; and

FIG. 6 is a front view schematically showing the structure of another embodiment of the vacuum evaporation apparatus in the present invention.

### DETAILED DESCRIPTION OF THE PREFERRED EMBODIMENTS

On the pages that follow, the substrate holder and the vacuum film deposition apparatus using the substrate holder according to the present invention are described in detail with reference to the preferred embodiments depicted in the accompanying drawings. In the following description, the present invention is applied to vacuum evaporation apparatuses but this is not the sole case of the present invention. It may also be applied to vacuum film deposition apparatuses using various vacuum film deposition processes (film deposition processes by means of vapor-phase deposition) such as sputtering and (plasma-enhanced) CVD.

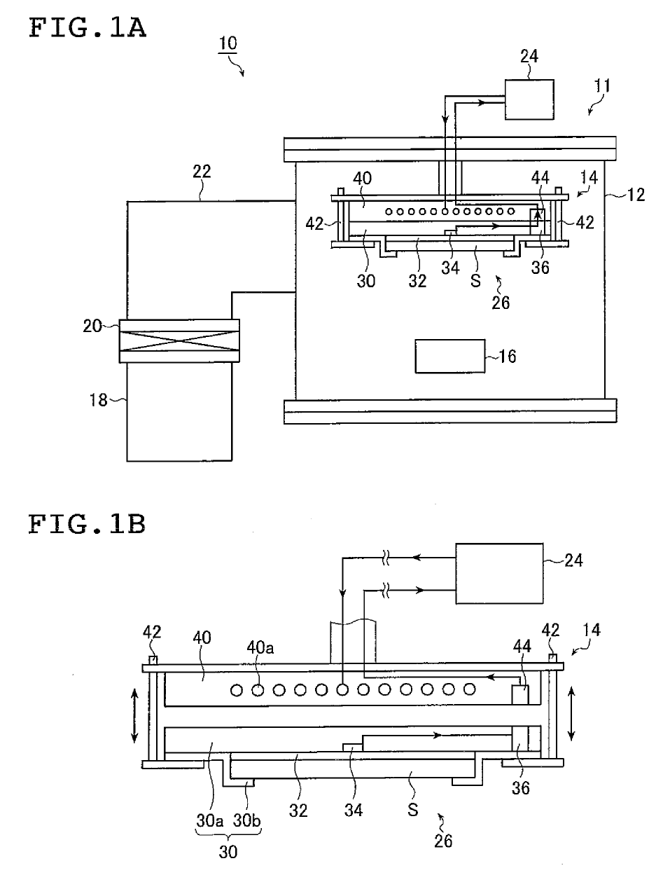

FIG. 1A is a front view schematically showing the structure of a vacuum evaporation apparatus 10 according to an embodiment of the vacuum film deposition apparatus of the present invention in which the substrate holder of the present invention is used. FIG. 1B is an enlarged front view showing in an enlarged scale a substrate holder 26 and a holder mounting section 14 of the vacuum evaporation apparatus 10 shown in FIG. 1A.

The vacuum evaporation apparatus 10 shown in FIG. 1A includes a single vacuum evaporation unit 11.

The vacuum evaporation unit 11 includes a vacuum chamber 12, the holder mounting section 14, an evaporation source 16, a vacuum pump 18, a valve 20, an evacuation line 22, a temperature control means 24 and the substrate holder 26.

In the vacuum evaporation apparatus 10, the vacuum chamber 12 is evacuated to reduce the internal pressure and an evaporable material filled into the evaporation source 16 is heated to melt and evaporate to form a film of the evaporated material on the surface of a substrate S held by the substrate holder 26, which in turn is supported by the holder mounting section 14.

In addition to the illustrated components, the vacuum evaporation unit 11 of the present invention may of course include various components of vacuum evaporation apparatuses or vacuum evaporation units, as exemplified by a gas introducing means for introducing various gases such as inert gases (e.g., argon) into the vacuum chamber 12, a shutter for blocking out vapors from the evaporation source 16, and a deposition preventing cover which guides the material evaporated from the evaporation source 16 to the substrate S to prevent deposition of the evaporated material to other areas than the substrate S.

There is no particular limitation on the substrate S used in the present invention, and use may be made of various materials appropriate to products to be obtained, as exemplified by a glass plate, a plastic (resin) film or plate, and a metal plate.

Any film may be deposited (formed) on the substrate S without particular limitations, and films capable of being deposited by vacuum evaporation are all available.

As will be described later in detail, the vacuum film deposition apparatus of the present invention is capable of measurement of the substrate temperature under fixed conditions, so that a film can be formed on the substrate by vapor deposition at a constant temperature.

Therefore, the present invention is particularly suitable for formation of a thick film that requires vapor-depositing at a predetermined temperature for a certain period of time, and can be advantageously used in forming a photoconductive layer in a direct type radiation image detector (FPD), the photoconductive layer requiring a thickness of about 200 μm to about 1,000 μm. More particularly, an amorphous selenium film serving as the photoconductive layer of the FPD can be advantageously formed in a uniform manner under more constant temperature conditions, because selenium as the film-forming material evaporates at a low temperature.

In the case of using the vacuum film deposition apparatus of the present invention in manufacturing FPDs, the FPDs produced may be of an electric reading system which uses a film of photoconductive material such as amorphous selenium and a thin film transistor (TFT) and which involves collecting electron hole pairs (e-h pairs) emitted from the photoconductive film upon incidence of radiation and detecting them as an electric current from a portion where TFT switching was carried out to thereby obtain a radiation image, or of an optical reading system which includes a photoconductive layer for recording and a photoconductive layer for reading both formed of an amorphous selenium compound or the like and a charge accumulation layer of As₂Se₃ formed between these photoconductive layers and which involves accumulating latent image charges by irradiation with radiation, allowing the latent image charges to flow by irradiation with reading light and detecting them as an electric current to thereby obtain a radiation image.

The substrate holder 26 is first described.

The substrate holder 26 includes a substrate mounting unit 30 on which the substrate S is mounted, a thermally conductive sheet 32 which transmits heat from a temperature adjusting plate 40 to be described below, a measurement unit 34 which comes in contact with the substrate S to measure its temperature, and a signal output unit 36 which outputs measurements obtained in the measurement unit 34 in the form of signals, and holds the substrate S with its area where a film is to be vapor-deposited open.

The substrate mounting unit 30 includes a back-side support portion 30a which supports the back side of the substrate S and a front-side support portion 30b which supports the front side of the substrate S, and the substrate S is mounted on and supported by the substrate mounting unit 30 with its area where a film is to be vapor-deposited open.

The back-side support portion 30a is a plate member with a larger area than the substrate S and has the measurement unit 34 disposed at its surface facing the substrate S and the signal output unit 36 disposed at its one end. The measurement unit 34 will be described later.

The front-side support portion 30b has an opening formed to open the area on the front side of the substrate S where a film is to be vapor-deposited, and supports the edges on the front side of the substrate S.

The front-side support portion 30b and the back-side support portion 30a of the substrate mounting unit 30 holds the substrate S to fix it within the substrate holder 26 at its predetermined position.

The thermally conductive sheet 32 is a sheet member made of a thermally conductive material and is provided on the surface of the back-side support portion 30a facing the substrate S. The substrate S can be uniformly heated or cooled with high efficiency by providing the thermally conductive sheet 32 between the back-side support portion 30a of the substrate holder 26 and the substrate S.

Various thermally conductive sheets may be used for the thermally conductive sheet 32 and it is preferable to use sheets in which thermally conductive particles, thermally conductive fillers or the like are dispersed in resins such as silicone resins, acrylic resins and ethylene propylene resins.

The thermally conductive sheet 32 preferably has a non-adhesive layer on its surface facing the substrate S. Provision of the non-adhesive layer on the substrate S side facilitates attachment/detachment of the substrate S.

It is preferable to use a layer surface-treated by electron beam irradiation, a plastic film, or a coating layer of a non-adhesive resin for the non-adhesive layer or to perform powder processing on the surface of the thermally conductive sheet facing the substrate.

Next, the measurement unit 34 is provided at the surface of the back-side support portion 30a on the substrate S side, and measures the temperature of the substrate S held by the substrate mounting unit 30.

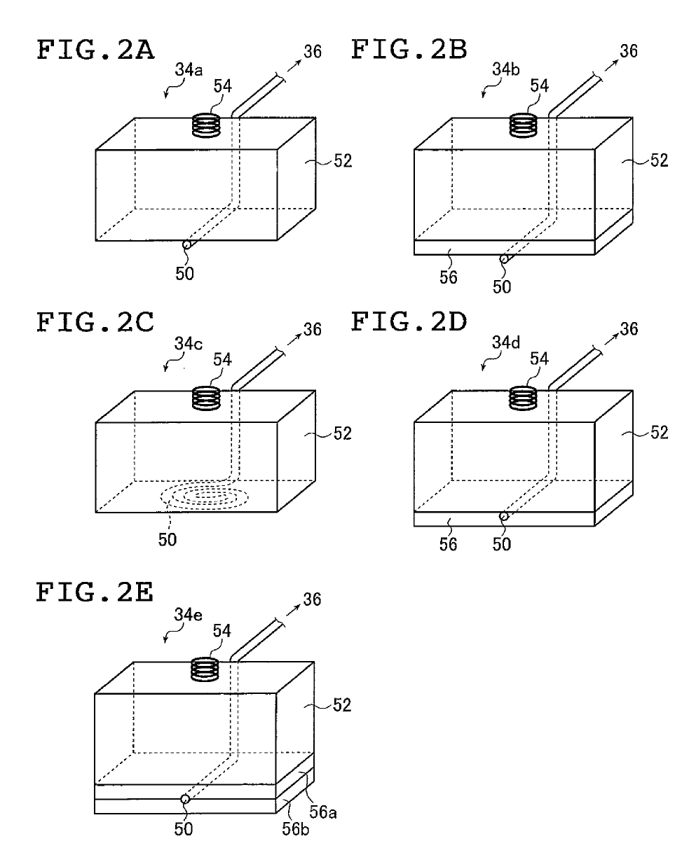

In the embodiment under consideration, the measurement unit 34 (more specifically its temperature measuring means 50; see FIGS. 2A-2E) comes into contact with the substrate S via the thermally conductive sheet 32 (and optionally a thermally conductive sheet 56), and can be deemed to be substantially in contact with the substrate S, because the thermally conductive sheet 32 is a member having high thermal conductivity.

In the illustrated embodiment, the measurement unit 34 has the temperature measuring means 50, an intermediate member 52, a pressing member 54 and optionally the thermally conductive sheet 56 integrated into a unit. The measurement unit 34 is inserted into a recess formed at the lower surface of the back-side support portion 30a of the substrate mounting unit 30 (at the surface facing the thermally conductive sheet 32) and disposed in the substrate holder 26.

FIGS. 2A to 2E are schematic perspective views showing the structures of examples of the measurement units 34 (34a to 34e).

In the present invention, there is no particular limitation on the temperature measuring means (temperature sensor) 50 for the substrate S, and various measuring means which come into contact with an object to measure its temperature may be used. Exemplary measuring means include a thermocouple in which both ends of two metal wires of different kinds are joined together and the temperature is measured from the thermoelectromotive force generated due to a difference in temperature between the points of contact at both ends, and a resistance temperature sensor or thermistor for use in measuring temperature from resistance that varies with temperature.

In the case of using any of the thermocouple, resistance temperature sensor and thermistor for the temperature measuring means (hereinafter referred to simply as the “sensor”) 50, two metal wires making up the thermocouple, resistance temperature sensor or thermistor are bundled together and accommodated in a cylindrical (sheathed) holder with high thermal conductivity.

Known pressing means such as a spring and an elastic member may be used for the pressing member 54. The pressing member 54 presses the intermediate member 52 downward to press the sensor 50 against the thermally conductive sheet 32 (or the substrate S)

A measurement unit 34a shown in FIG. 2A basically includes the sensor 50, the intermediate member 52 and the pressing member 54. The front view in FIG. 1A is made in the same direction as the direction from right to left in FIGS. 2A to 2E.

The measurement unit 34a has the pressing member 54 fixed to the upper surface of the intermediate member 52 (to the surface contacting the bottom of the recess formed in the back-side support portion 30a). The sensor 50 has an approximately Z shape with two 90° angle bends to be fitted to the intermediate member 52 in the shape of a rectangular parallelepiped. The sensor 50 is bonded to the intermediate member 52 with a straight tip portion of the sensor 50 and a straight portion following the straight tip portion via a 90° angle bent in contact with the lower surface (the surface on the side of the thermally conductive sheet 32 or the substrate S) and the lateral surface of the intermediate member 52, respectively.

As described above, the measurement unit 34 is inserted into the recess of the back-side support portion 30a. Therefore, the pressing member 54 presses the sensor 50 downward through the intermediate member 52 so that the sensor 50 is brought into close contact with or pressed against the thermally conductive sheet 32 to ensure stable contact between the thermally conductive sheet 32 and the sensor 50, thus enabling the temperature of the substrate S to be measured or adjusted with high accuracy.

A measurement unit 34b shown in FIG. 2B has a structure in which the thermally conductive sheet 56 is applied to the lower surface of the intermediate member 52 in the measurement unit 34a shown in FIG. 2A and the sensor 50 (its straight tip portion) is adhered to the lower surface of the thermally conductive sheet 56.

The sensor 50 attached to the intermediate member 52 via the thermally conductive sheet 56 is pressed against the thermally conductive sheet 32 by the intermediate member 52 (pressing member 54) to be sandwiched between the two thermally conductive sheets, which brings the sensor 50 into more stable contact with the thermally conductive sheet 32, thus enabling the temperature of the substrate S to be measured with high accuracy. Even in the case where no thermally conductive sheet 32 is provided on the back side of the substrate S, the pressing operation causes the sensor 50 to sink into the thermally conductive sheet 56 of the measurement unit 34b, so that the sensor 50, the thermally conductive sheet 56 and the substrate S are brought into stable contact with each other to enable highly accurate measurement of the temperature of the substrate S.

The shape of the sensor 50 is not limited to a linear shape but the portion underlying the intermediate member 52 may have a spiral shape as in a measurement unit 34c shown in FIG. 2C The sensor 50 having such a shape enables more stable contact between the thermally conductive sheet 32 (substrate S) and the sensor 50 to measure the temperature of the substrate S with high accuracy.

By applying the structure shown in FIG. 2C in which the sensor 50 has a spiral shape to the structure shown in FIG. 2B and also to the structures shown in FIGS. 2D and 2E to be described later where the measurement unit 34 has the thermally conductive sheet 56, the thermally conductive sheet 32 (substrate S) and the sensor 50 can be brought into more stable contact with each other to carry out temperature measurement with high accuracy.

A measurement unit 34d shown in FIG. 2D has a structure in which the sensor 50 is sandwiched between the intermediate member 52 and the thermally conductive sheet 56 instead of providing the sensor 50 under the lower surface of the thermally conductive sheet 56 as in the measurement unit 34b shown in FIG. 2B.

This structure in which the sensor 50 is sandwiched between the intermediate member 52 and the thermally conductive sheet 56 stably fixes the contact between the sensor 50 and the thermally conductive sheet 56. As a result, irrespective of whether the thermally conductive sheet 32 is provided on the back side of the substrate S, the sensor 50 can be brought into stable contact with the thermally conductive sheet 32 or the substrate S via the thermally conductive sheet 56 to carry out highly accurate temperature measurement.

Furthermore, a laminate of two thermally conductive sheets 56a and 56b between which the sensor 50 is sandwiched may be provided under the lower surface of the intermediate member 52 as in a measurement unit 34e shown in FIG. 2E, which enables more stable contact between the sensor 50 and the thermally conductive sheet 32 or the substrate S to achieve temperature measurement with higher accuracy.

In the preferred embodiment, the illustrated substrate holder 26 has the thermally conductive sheet 32 provided on the back side of the substrate S to advantageously carry out temperature control of the substrate S. However, this is not the sole case of the present invention and the substrate holder 26 of the present invention may not be provided with the thermally conductive sheet 32.

Even in the case where the substrate holder 26 has no thermally conductive sheet 32 and the measurement unit 34 has no thermally conductive sheet 56 (as in the measurement unit 34a shown in FIG. 2A and the measurement unit 34c shown in FIG. 2C), in the illustrated measurement unit 34, the pressing member 54 presses the sensor 50 via the intermediate member 52 against the sensor S to enable stable contact between the sensor 50 and the substrate S and highly accurate temperature measurement. It is needless to say that, not only in the measurement units 34b, 34d and 34e under which the thermally conductive sheet 56 is provided but also in the measurement units 34a and 34c under which it is not provided, when the substrate holder 26 has the thermally conductive sheet 32, the sensor 50 is brought into more stable contact with the substrate S through the thermally conductive sheet 32 to enable the temperature to be measured with higher accuracy.

The illustrated measurement unit 34 is preliminarily assembled into a unit. However, this is not the sole case of the present invention and the measurement unit 34 may be assembled when setting the substrate S in the substrate holder 26.

Irrespective of the structure applied, the substrate holder 26 in which the substrate S is set can be transported to a plurality of vapor deposition chambers (vacuum evaporation apparatuses) with the sensor 50 pressed against or brought into contact with the thermally conductive sheet 32 (or the substrate S) at a given pressure.

The signal output unit 36 is provided at one end of the back-surface support portion 30a and is connected to the measurement unit 34 by wiring. The signal output unit 36 outputs signals outputted from the measurement unit 34 to a signal receiving unit 44.

In the illustrated substrate holder 26, the signal output unit 36 outputs temperature measurement signals (electric signals) from the measurement unit 34 (sensor 50) to the signal receiving unit 44 without any further processing. However, this is not the sole case of the present invention, and the signal output unit 36 may output temperature measurement signals from the measurement unit 34 to the signal receiving unit 44 after conversion to digital signals.

The vacuum chamber 12 is a highly airtight vessel made of iron, stainless steel, aluminum, etc. Various vacuum chambers (e.g. bell jar and vacuum vessel) employed in apparatuses for vacuum evaporation may be used for the vacuum chamber 12. To the vacuum chamber 12 is connected the vacuum pump 18 via the evacuation line 22, which in turn is provided with the valve 20 which hermetically seals the evacuation line 22 and adjusts the amount of air discharged through the vacuum pump 18. Various valves such as a solenoid valve and a hydraulic valve may be used for the valve 20.

The vacuum pump 18 evacuates the vacuum chamber 12 to reduce the internal pressure to a predetermined degree of vacuum.

Various types of vacuum pumps as used in vacuum evaporation apparatuses can be used for the vacuum pump 18 without any particular limitation as long as they help to attain the requisite vacuum level. For example, an oil diffusion pump, a cryogenic pump, a turbomolecular pump or any other pump may be used optionally in combination with a cryogenic coil.

The holder mounting section 14 includes the temperature adjusting plate 40 that heats and/or cools the substrate holder 26 and the substrate S, a holder support portion 42 that supports the substrate holder 26, and the signal receiving unit 44 that receives the signals outputted from the signal output unit 36 of the substrate holder 26.

The substrate holder 26 is detachably mounted to the holder support portion 42 (hooks of the holder support portion 42 to be described later) by any known means.

The temperature adjusting plate 40 is a plate member having a temperature adjusting mechanism 40a disposed therein and is provided on the upper surface within the vacuum chamber 12.

The temperature adjusting plate 40 heats or cools the substrate holder 26 to adjust the temperature of the substrate S.

A method of heating or cooling the temperature adjusting plate 40 by circulating a heating medium in piping provided within the temperature adjusting plate 40 and a method of heating or cooling the temperature adjusting plate 40 by controlling the current applied to a Peltier device provided within the temperature adjusting plate 40 are used for the temperature adjusting mechanism 40a. In the case where the temperature adjusting plate 40 is temperature-controlled only by heating, use may also be made of a method in which heating wires are arranged and heated.

The holder support portion 42 is disposed at the temperature adjusting plate 40 and has hooks for supporting the periphery of the substrate holder 26. The hooks in the holder support portion 42 are moved by an elevator mechanism in the vertical direction in FIG. 1A.

The holder support portion 42 moves the hooks for supporting the substrate S (substrate holder 26) to the temperature adjusting plate 40 side to support the edges of the substrate holder 26 from the surface of the substrate holder 26 on the evaporation source 16 side such that the substrate holder 26 (more specifically, the back-side support portion 30a) is brought into close contact with the temperature adjusting plate 40.

In the case where the substrate holder 26 after the end of vapor deposition is detached from the holder support portion 42, the holder support portion 42 is moved to the side of the evaporation source 16 and the substrate holder 26 is released from the state in which the substrate holder 26 is in close contact with the temperature adjusting plate 40, then detached.

For the elevator mechanism, use may be made of a linear mechanism, a movement mechanism by means of a force applied by a spring, and a movement mechanism by means of a wire.

The signal receiving unit 44 is disposed at the surface of the temperature adjusting plate 40 on the substrate holder 26 side. When the substrate holder 26 is held, the signal receiving unit 44 comes into contact with the signal output unit 36 of the substrate holder 26 to receive signals outputted from the signal output unit 36.

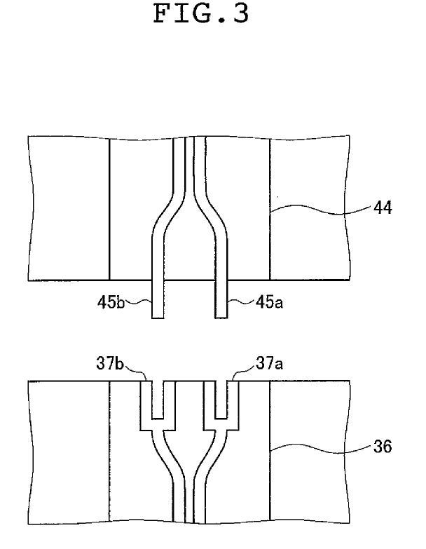

FIG. 3 schematically shows in an enlarged scale the signal output unit 36 and the signal receiving unit 44.

As described above, the sensor (temperature measuring means) 50 is obtained by bundling together two metal wires making up the thermocouple, resistance temperature sensor or thermistor and accommodating them in a cylindrical holder with high thermal conductivity. The signal output unit 36 has sockets 37 (first socket 37a and second socket 37b) electrically connected to the individual metal wires. On the other hand, the signal receiving unit 44 has terminals 45 (first terminal 45a and second terminal 45b) which are connected to (electric) signal lines independent of each other and are inserted and fitted into the first and second sockets 37a and 37b, respectively. The present invention may be configured such that the signal output unit 36 has the terminals 45, whereas the signal receiving unit 44 has the sockets 37.

When the holder support portion 42 elevates the substrate holder 26 (hooks) to bring the substrate holder 26 into close contact with the temperature adjusting plate 40 as described above, the terminals 45 are inserted and fitted into the sockets 37 to electrically connect the signal output unit 36 with the signal receiving unit 44.

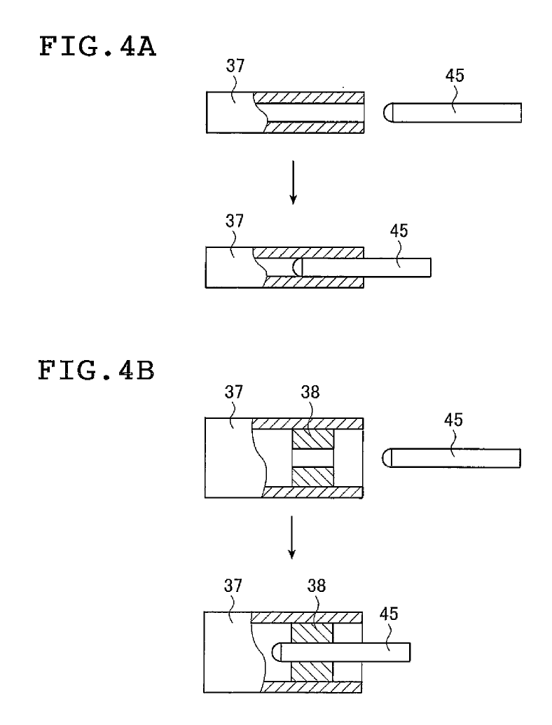

There is no particular limitation on the shapes of the socket 37 and the terminal 45, and it is preferable to apply a configuration in which the terminal 45 in a rod shape (cylindrical shape) is fitted or press-fitted into the socket 37 in a cylindrical shape, as schematically shown in FIG. 4A. In an alternative configuration, the terminal 45 in a rod shape is press-fitted into the socket 37 in a cylindrical shape such that the terminal 45 can be press-fitted into a conductive member 38 provided within the socket 37.

In order to perform accurate temperature measurement, it is important to prevent contact electric resistance between the signal output unit 36 and the signal receiving unit 44 (at the connector portion therebetween). The above configuration improves the contact force between the signal output unit 36 and the signal receiving unit 44 and therefore the contact area to enable a signal to be more consistently outputted from the signal output unit 36 to the signal receiving unit 44.

The evaporation source 16 is provided on the lower side in the vertical direction than the holder mounting section 14 so as to face the holder mounting section 14 within the vacuum chamber 12. The evaporation source 16 heats to melt an evaporable material, then evaporates it toward the substrate S.

As the evaporation source 16, use may be made of, for example, an evaporation source which includes a crucible accommodating (containing) the evaporable material and a heating source for heating the crucible and therefore the evaporable material filled thereinto and in which the evaporable material is heated to evaporate by resistance heating of the crucible from the heating source.

The evaporation source is not limited to the one having the above-mentioned structure, and various types of crucibles including so-called boat-type crucibles and cylindrical or cup-type crucibles that open at their upper ends are all available.

The heating mechanism for the evaporation source is not limited to a heating mechanism in which an electric current is applied to the crucible for resistance heating to heat the crucible. Various heating mechanisms that may be used in vacuum evaporation are all available as long as induction heating and electron beam (EB) heating can be used in accordance with the film-forming conditions such as the degree of vacuum upon vapor deposition.

The evaporation source may be provided with a temperature measuring means for measuring the temperature of the evaporable material (or the crucible). An example of the temperature measuring means that may be used includes a thermocouple.

The temperature is measured by the temperature measuring means and the amount of heating in the evaporation source is adjusted based on the measurement results, enabling the temperature of the evaporable material to be kept constant, thus leading to consistent evaporation of the evaporable material.

The vacuum evaporation unit 11 of the embodiment under consideration uses a single evaporation source 16, but this is not the sole case of the present invention. The vacuum evaporation unit 11 may have a plurality of evaporation sources 16 disposed therein or may perform multi-source vacuum evaporation with a plurality of evaporation sources 16 containing different evaporable materials.

The temperature control means 24 controls the amount of heating or cooling in the temperature adjusting mechanism 40a based on the measurements in the measurement unit 34 received by the signal receiving unit 44 to thereby adjust the temperature of the substrate S to a desired value.

The substrate holder and the vacuum film deposition apparatus of the present invention are described below in greater detail with reference to the operation of the vacuum evaporation apparatus 10 shown in FIGS. 1A and 1B.

First, the substrate S is accommodated into the substrate holder 26.

Then, the evaporation source 16 is charged with a predetermined amount of evaporable material and the substrate holder 26 containing the substrate S is mounted on the holder mounting section 14 at its predetermined position More specifically, the substrate holder 26 is secured with the hooks to the holder mounting section 14 to bring the back-side support portion 30a into close contact with the temperature adjusting plate 40 and connect the signal receiving unit 44 with the signal output unit 36.

Then, the vacuum chamber 12 is closed and evacuated by the vacuum pump 18 to a predetermined degree of vacuum.

The vacuum pump 18 is used to evacuate the system (i.e., the vacuum chamber 12) to a high degree of vacuum. Further, it is preferable to introduce argon gas into the system through a gas introducing means to achieve a degree of vacuum between about 0.01 Pa and 3 Pa (which is hereinafter referred to as medium vacuum for the sake of convenience).

When the vacuum chamber 12 has reached a predetermined degree of vacuum, an electric current is applied to the evaporation source 16 to start heating the evaporable material.

Then, at the point in time when the evaporable material (and/or the crucible) has reached a predetermined temperature, formation of a film on the substrate S by vapor deposition is started.

When the film is vapor-deposited on the substrate S, the measurement unit 34 measures the temperature of the substrate S. The measurement data is sent to the signal output unit 36, then to the signal receiving unit 44 to be received by the temperature control means 24, which adjusts the amount of heating or cooling in the temperature adjusting plate 40 based on the temperature measurement data of the substrate S obtained in the measurement unit 34 and sent (i.e., outputted) from the signal output unit 36.

When the vapor-deposited film with a predetermined thickness has been formed, heating of the evaporation source 16 is stopped. The vacuum chamber 12 is restored to atmospheric pressure and opened, and the substrate S having the film vapor-deposited thereon is taken out from the vacuum chamber 12.

The thickness of the vapor-deposited film (film thickness) may be controlled by the film deposition rate corresponding to the predetermined heating conditions or based on the film thickness directly measured with a displacement gauge or other instrument. Alternatively, the film thickness may be controlled with a meter for measuring the quantity of evaporation using a crystal oscillator or the like.

In this way, the vacuum evaporation apparatus 10 uses the evaporable material to vapor-deposit a film on the substrate S.

According to the present invention, by providing the substrate holder for holding the substrate with the measurement unit as described above, the state of contact between the substrate and the measurement unit or the position where they are in contact with each other can be made constant to measure the substrate temperature under the constant condition. In other words, the substrate temperature can be accurately measured and optionally controlled.

The signal output unit of the substrate holder and the signal receiving unit of the holder mounting section can be detachably mounted into the vacuum evaporation unit. In addition, the measurements can be taken out from the substrate holder in the form of electric signals irrespective of the state of contact between the signal output unit and the signal receiving unit.

The measurements can be obtained under the constant condition to adjust the substrate temperature in a consistent manner, thus enabling a uniform high-quality film to be vapor-deposited on the substrate.

In this way, a uniform high-quality film can be formed on the substrate by vapor deposition even in the case of vapor-depositing a thick film at a low temperature.

The substrate temperature can be thus stabilized to advantageously form a thick photoconductive layer in a direct-type radiation image detector (FPD) and in particular a vapor-deposited film of amorphous selenium serving as the photoconductive layer of the FPD.

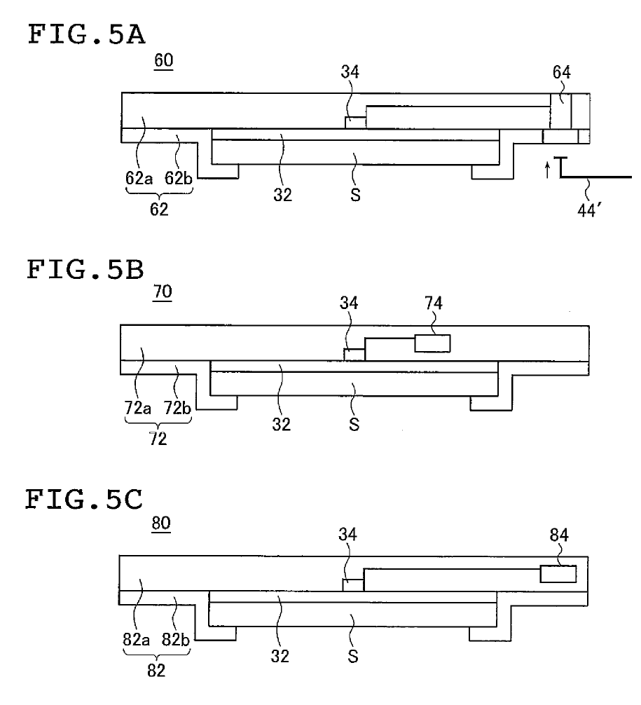

In the embodiment under consideration, the signal output unit of the substrate holder is provided so as to expose on both of the upper and lower surface sides. However, the present invention is not limited to this embodiment. FIGS. 5A to 5C are schematic front views showing the structures of other embodiments of the substrate holder of the present invention.

A substrate holder 60 shown in FIG. 5A has a signal output unit 64 provided in a back-side support portion 62a of a substrate mounting unit 62. An opening is formed in the portion of a front-side support portion 62b facing the signal output unit 64 to expose the surface of the signal output unit 64 on the side of the front-side support portion 62b.

The signal output unit 64 may be provided in the back-side support portion 62a of the substrate holder 60 to connect a signal receiving unit 44′ to the signal output unit 64 from the front-side support portion 62b side. In this case, it is also preferable for the signal output unit 64 and the signal receiving unit 44′ to be configured such that the latter is press-fitted into the former as shown in FIGS. 4A and 4B, and vice versa.

A substrate holder 70 shown in FIG. 5B has a signal output unit 74 provided within a back-side support portion 72a of a substrate mounting unit 72. FIG. 5B also shows a front-side support portion 72b.

The signal output unit 74 outputs by radio the measurement data obtained in the measurement unit 34, which enables a signal receiving unit to receive the signals without contacting the signal output unit.

The signal receiving unit can be thus disposed at any desired position to further facilitate wiring while offering a higher degree of flexibility in designing the substrate holder and the vacuum evaporation apparatus.

In the embodiments described above, the temperature adjusting mechanism of the temperature adjusting plate is adjusted for heating or cooling based on the temperature measurement data of the substrate which was obtained in the measurement unit, and sent to and received by the signal receiving unit. However, the measurement data may be recorded in the signal output unit.

A substrate holder 80 shown in FIG. 5C also has a signal output unit 84 provided within a back-side support portion 82a of a substrate mounting unit 82. FIG. 5C also shows a front-side support portion 82b.

The signal output unit 84 has a recorder for storing measurements where the measurement data obtained in the measurement unit 34 is recorded. The measurement results recorded in the recorder of the signal output unit 84 is read out after the end of vapor deposition onto the substrate S.

In the case where the measurement data has been thus recorded in the signal output unit 84, the temperature control means calculates predicted temperature variations through analysis of the measurement data having been recorded in the recorder and adjusts the amount of heating or cooling in the temperature adjusting mechanism based on the predicted temperature variations.

The present invention is not limited to outputting measurement data to the signal receiving unit during film deposition without further processing (i.e., by real-time processing), and the substrate temperature can also be consistently adjusted by recording measurement data in the recorder provided in the signal output unit and predicting the temperature variations based on the detected measurement data. It is possible to accurately predict the temperature variations by calculating the predicted temperature variations from a large amount of measurement data.

The apparatus configuration can be facilitated by recording measurement data in the signal output unit and outputting it when no substrate is mounted on the holder mounting section 14 because there is no need to provide the holder mounting section with the signal receiving unit.

In the embodiments described above, a single measurement unit is provided in the substrate holder, but a plurality of measurement units (measurement terminals) are preferably provided therein.

The substrate temperature can be more reliably detected under the more constant condition by measuring the temperature at a plurality of points of the substrate where the measurement terminals are disposed. Also in this case, the measurements can be outputted from a single signal output unit to facilitate the apparatus configuration.

The temperature control for each area of the substrate is also possible by detecting the substrate temperature at a plurality of points.

In the embodiment shown in FIGS. 1A and 1B, it is preferable that a thermally conductive sheet (heat conductive sheet) for uniformly transmitting heat to the substrate S be provided under the lower surface of the temperature adjusting plate 40, that is, between the temperature adjusting plate 40 and the substrate holder 26. Provision of the thermally conductive sheet enables heat from the temperature adjusting plate 40 to be uniformly transmitted to the substrate holder with high efficiency.

The heating/cooling mechanism is provided within the temperature adjusting plate in this embodiment. However, this is not the sole case of the present invention, and the temperature adjusting plate may comprise a holding plate for holding the substrate holder and a heating/cooling mechanism disposed on an opposite side of the holding plate from the surface at which the holding plate comes in contact with the substrate holder. In this case, it is preferable to provide the above-mentioned thermally conductive sheet between the holding plate and the heating/cooling mechanism as well.

In this embodiment, film deposition is made with the substrate fixed. However, the present invention is not limited to this and the substrate may be rotated or reciprocated when the evaporable material is deposited to form a film.

The vacuum film deposition apparatus of the present invention preferably includes a means for transporting the substrate S (substrate holder 26) and a plurality of vacuum evaporation units connected to each other such that a plurality of films can be formed on the single substrate S.

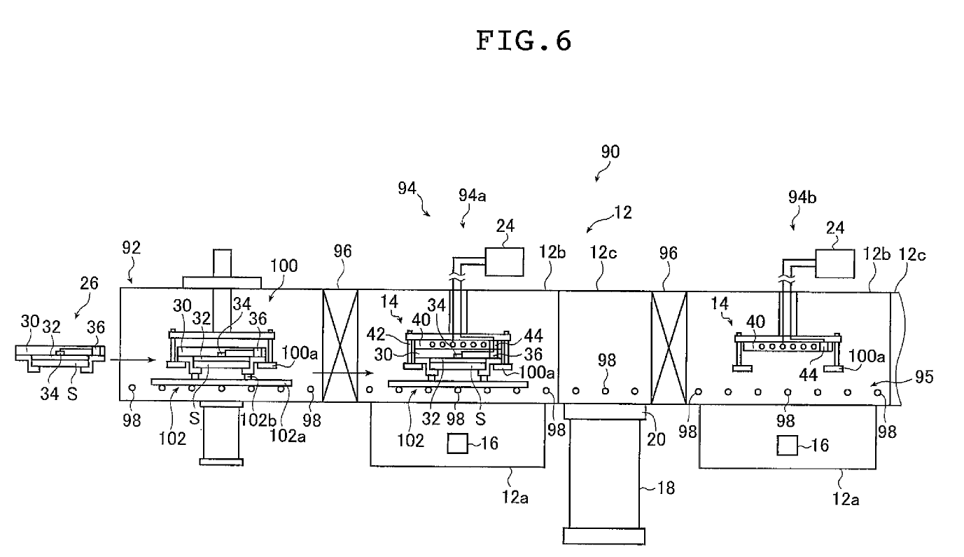

FIG. 6 is a schematic front view showing the structure of an embodiment of the vacuum film deposition apparatus of the present invention.

A vacuum evaporation apparatus 90 is an application of the (vacuum) evaporation apparatus 10 shown in FIG. 1A, and includes a substrate preparation unit (hereinafter referred to as a “preparation unit”) 92 and vacuum evaporation units 94 including a first vacuum evaporation unit 94a, a second vacuum evaporation unit 94b etc., and a substrate holder transport mechanism 95. The vacuum evaporation unit 94 is configured in the same manner as the vacuum evaporation unit 11 of the vacuum evaporation apparatus 10 as described above, so its detailed description is omitted.

Shutters 96 are provided between the preparation unit 92 and the first vacuum evaporation unit 94a adjacent thereto and between the adjacent vacuum evaporation units 94. The shutter 96 is opened to make the preparation unit 92 or any of the vacuum evaporation units 94 communicate with the vacuum evaporation unit adjacent thereto, and is closed to hermetically shut its corresponding units.

In each of the vacuum chambers, the substrate holder transport mechanism 95 for transporting a substrate holder 26 has transport rollers 98.

In the vacuum evaporation apparatus 90 as well, a substrate S is accommodated in the substrate holder 26 to be used in film deposition. In the preparation unit 92, a setting means 100 sets the substrate holder 26 on a transport carrier 102.

For example, the lower end of a hook 100a of the setting means 100 is inserted under the substrate holder 26 to hold the substrate holder 26 from the bottom to set it on the transport carrier 102.

The transport carrier 102 has a body 102a and setting members 102b which support a front-side support portion 30b (see FIG. 1B) of a substrate mounting unit 30 in the substrate holder 26. The setting means 100 sets the substrate holder 26 on the setting members 102b.

The transport carrier 102 is moved by the transport rollers 98. In other words, the substrate holder 26 (substrate S) is set on the transport carrier 102 and moved by the transport rollers 98 to the respective vacuum evaporation units 94.

In the illustrated case, a vacuum chamber 12 in each of the vacuum evaporation units 94 includes three parts, that is, a film deposition part 12a, a substrate holding part 12b and a transport part 12c. A vacuum pump 18 is connected to the transport part 12c through a valve 20. In other words, in each of the illustrated vacuum evaporation units 94, the transport part 12c serves as the evacuation line 22 described above.

The film deposition part 12a is provided with an evaporation source 16. The substrate holding part 12b includes the aforementioned substrate mounting section 14 (except the substrate holder 26) and the transport rollers 98.

As in the aforementioned vacuum evaporation unit 11, the holder mounting section 14 of the vacuum evaporation unit 94 is provided with a holder support portion 42 having hooks. Like the setting means 100 of the preceding preparation unit 92, the holder support portion 42 inserts the lower end of each of the hooks under the substrate holder 26 to support it from the bottom.

Support of the substrate holder 26 with the hooks of the holder mounting section 14 (and the setting means 100) is not the sole case of the present invention but various known methods may be used.

The operation of the vacuum evaporation apparatus 90 is described below.

When the substrate holder 26 is fed to a predetermined position of the preparation unit 92 in the illustrated vacuum evaporation apparatus 90, the setting means 100 holds the substrate holder 26 with the hooks 100a to set it on the transport carrier 102 disposed at a predetermined position.

When the substrate holder 26 is set on the transport carrier 102 in the preparation unit 92, corresponding one or more shutters 96 are opened to allow the transport carrier 102 to be transported by the transport rollers 98 to any of the vacuum evaporation units 94 (e.g., to the first vacuum evaporation unit 94a).

The transport carrier 102 having the substrate holder 26 set thereon is transported to a predetermined position under the holder mounting section 14 of the substrate holding part 12b by the transport rollers 98 (i.e., the substrate holder transport mechanism 95).

When the transport carrier 102 is stopped, the hooks of the holder support portion 42 moves downward to support the substrate holder 26. Once the substrate holder 26 is supported by the hooks, the holder support portion 42 lifts with the hooks the substrate holder 26 from the transport carrier 102 to bring a back-side support portion 30a (see FIG. 1B) of the substrate mounting unit 30 in the substrate holder 26 into close contact with a temperature adjusting plate 40. A signal output unit 36 of the substrate holder 26 is also brought into contact with a signal receiving unit 44 disposed in the temperature adjusting plate 40.

Then, the transport carrier 102 is transported in the opposite direction by the transport rollers 98 to the preparation unit 92 and the corresponding one or more shutters 96 are closed to hermetically seal the vacuum chamber 12.

Upon closure of the shutters 76, evacuation of the vacuum chamber and heating of the film-forming material are started as in the aforementioned vacuum evaporation apparatus 10. At the point in time when a predetermined degree of vacuum has been reached, a film is formed on the substrate S by vacuum evaporation.

When a film with a predetermined thickness has been formed on the substrate S, the evaporation source 16 stops heating the evaporable material.

Then, when the vacuum evaporation unit 94 is opened to the atmosphere (or adjusted to a predetermined pressure), the corresponding one or more shutters 96 are opened to allow the substrate carrier 102 to be transported by the transport rollers 98 to a predetermined position under the holder mounting section 14 of the substrate holding part 12b.

Thereafter, the holder support portion 42 moves the substrate holder 26 downward to a predetermined position, where the holder support portion 42 releases the substrate holder 26 held by the hooks to set the substrate holder 26 on the setting members 102b of the substrate carrier 102.

Once having been set on the substrate carrier 102, the substrate holder 26 is transported to the following vacuum evaporation unit 94 by the transport rollers 98 and the next layer is formed in the same manner as above.

Also in the case of forming a multi-layered film on the substrate by vapor deposition, the substrate temperature can be thus measured under the same conditions by using the substrate holder of the present invention.

The signal receiving unit provided in each of the vacuum evaporation units can acquire the measurement data from the measurement unit of the substrate holder, so the substrate can be transported independently. In addition, the signal output unit is a portion from which the measurement data from the measurement unit is outputted in the form of digital signals and hence there is no change in the measurement results irrespective of the state of contact between the signal output unit and the signal receiving unit. Therefore, even in the case where the substrate holder is moved and signals are acquired in any of the different signal receiving units, the detection values can be prevented from varying with the state of contact between the signal output unit and the signal receiving unit, thus achieving accurate temperature measurement.

The substrate temperature can be adjusted based on the substrate temperature values detected accurately to form a high-quality film on the substrate by vapor deposition while maintaining the substrate at a desired temperature.

While the substrate holder and the vacuum film deposition apparatus of the present invention have been described above in detail, the present invention is by no means limited to the foregoing embodiments and it should be understood that various improvements and modifications can of course be made without departing from the scope and spirit of the invention.

The above description has been made by applying the present invention to vacuum evaporation apparatuses using as a film deposition means the evaporation source 16 which is heated to melt an evaporable material accommodated therein. However, as described above, the present invention may be applied to various known vacuum film deposition apparatuses such as sputtering apparatuses which include a plasma generation means and a target holding means as the film deposition means, and (plasma-enhanced) CVD apparatuses which include a reactive gas introducing means and the like as the film deposition means. By applying the present invention to such vacuum film deposition processes as sputtering and (plasma-enhanced) CVD, the substrate temperature can be measured under the constant condition and properly controlled as in the vacuum evaporation having been described in detail to thereby form a high-quality thin film on the substrate uniformly.

What is claimed is:

1. A substrate holder comprising:
a holding unit which holds a substrate;
a temperature measurement unit which is provided at a surface on a substrate side of said holding unit and is brought into contact with said substrate to measure a temperature of said substrate; and
a signal output unit which outputs temperature measurement signals from said temperature measurement unit.

2. The substrate holder according to claim 1, wherein said temperature measurement unit has measurement terminals for measuring the temperature of said substrate and measures the temperature at a plurality of positions of said substrate.

3. The substrate holder according to claim 1, wherein said signal output unit outputs by radio the temperature measurement signals.

4. The substrate holder according to claim 1, further comprising a thermally conductive member which is provided on the surface on the substrate side of said holding unit and said temperature measurement unit is in contact with said substrate via the thermally conductive member.

5. A vacuum film deposition apparatus comprising at least one vacuum film deposition unit, said at least one vacuum film deposition unit comprising:
a substrate holder including:
a holding unit which holds a substrate;
a temperature measurement unit which is provided at a surface on a substrate side of said holding unit and is brought into contact with said substrate to measure a temperature of said substrate; and
a signal output unit which outputs temperature measurement signals from said temperature measurement unit;
a vacuum chamber within which said substrate holder is provided;
a holder support portion which is provided within said vacuum chamber, is connected to a connection portion of said substrate holder and supports said substrate holder;
a film deposition device which forms a film by vacuum film deposition on said substrate held in said substrate holder supported by said holder support portion; and
a signal receiving unit which is connected to said signal output unit and receives said temperature measurement signals.

6. The vacuum film deposition apparatus according to claim 5, further comprising a temperature adjusting mechanism which adjusts the temperature of said substrate based on said temperature measurement signals received by said signal receiving unit.

7. The vacuum film deposition apparatus according to claim 5, wherein said at least one vacuum film deposition unit comprises a plurality of vacuum film deposition units and the vacuum film deposition apparatus further comprises a transport mechanism which transports said substrate holder from one of said plurality of vacuum film deposition units to another.

8. The vacuum film deposition apparatus according to claim 5, wherein said temperature measurement unit has measurement terminals for measuring the temperature of said substrate and measures the temperature at a plurality of positions of said substrate.

9. The vacuum film deposition apparatus according to claim 5, wherein said signal output unit outputs by radio the temperature measurement signals.

10. The vacuum film deposition apparatus according to claim 5, wherein said substrate holder further comprises a thermally conductive member which is provided on the surface on the substrate side of said holding unit and said temperature measurement unit is in contact with said substrate via the thermally conductive member.
